(19) United States
(12) Patent Application Publication
(10) Pub. No.: US 2020/0410055 A1
(43) Pub. Date: Dec. 31, 2020

(54) SYSTEMS AND METHODS FOR IMPROVING BUSINESS COMMUNICATIONS USING NATURAL LANGUAGE PROCESSING

(71) Applicant: JPMORGAN CHASE BANK, N.A., New York, NY (US)

(72) Inventors: Lukas BACKIS, New York, NY (US); Greg TUCKER, New York, NY (US); Elliot ALKER, New York, NY (US)

(21) Appl. No.: 16/455,122

(22) Filed: Jun. 27, 2019

(51) Int. Cl. G06F 17/27; G06N 3/08; G06K 9/62

(52) U.S. Cl. CPC G06F 17/2785; G06K 9/623; G06N 3/08; G06F 17/2735

(57) ABSTRACT

Systems and methods for improving business communication are provided. The system includes a processor, a memory, and a user interface coupled to each of the processor, and the memory. The processor is configured to receive and read the text of a business communication; identify one or more words in the text of the business communication for evaluation of objectivity, apply an objectivity rule and generate an objectivity score for the one or more identified words. The method further determines whether the objectivity score is low using a control table and provides a replacement word for an identified word having a low objectivity score.

### BACKGROUND OF THE INVENTION

### Field of the Invention

The present application relates to the field of natural language processing, and more specifically to the application of natural language processing in the area of business communications. In a broader sense, the method and system disclosed here are applicable to any area in which there is a need for extracting contextual language from free-text.

### Description of the Related Art

Tone in business communications writing refers to the writer's attitude toward the reader and the subject of the message. The overall tone of a written message affects the reader just as one's tone of voice affects the listener in everyday exchanges. (Scott Ober, Contemporary Business Communication. 2nd Edition. Boston: Houghton Mifflin, 1995.)

Tone is present in all business communications, such as a memo, letter, report, or any type of business document. Not only does the tone of a message provide a reflection on the writer, it also determines how the reader will perceive the message.

Text based communications written in a natural language are largely inaccessible to computer programs, whereas, textual data in coded form can be accessed by a computer and used for further analysis or processing. Natural language processing (“NLP”) allows a computer system to “read” free-text documents, convert the language in these documents to concepts, and capture these concepts and words. While NLP has been a topic of interest for many years, its use in improving the tone of written communications is lacking.

### SUMMARY OF THE INVENTION

The present application is intended to cover the processing of text input. More particularly, it relates to the use of natural language processing techniques for determining objectivity of the text input. It includes to information retrieval, machine translation, natural language understanding, such as document similarity/clustering, which are useful in a variety of applications, including in improving business communications. However, for purposes of illustration only, primarily, a description of the present application is provided in the context of written business communications.

In technical writing, public relations, professional communications, and opinions. Tone in a communication may introduce subjectivity which in general can often be out of place and may portray a different image than desired. Inappropriate tone may connote emotional response and judgment. Inappropriate tone may connote an emotional or a judgmental quality in the written communication. On the other hand, in some situations, such as discussion of tragic events, it may be very appropriate to inject emotion and subjectivity. Choosing the correct vocabulary for various situations is a non-trivial task making it difficult for the writer to gauge how their own text may be perceived.

In one embodiment, the system uses a natural language processing algorithm to determine how objective or subjective a piece of text appears to be by giving the user a subjectivity/objectivity score. It does not assess the meaning of the content, rather the choice of vocabulary. A user may then incorporate the suggestion to improve the communication in order to improve the idea they are trying to convey.

In an embodiment, the system includes an algorithm that suggests replacement words for flagged or identified words that have low objectivity score (conversely, a high subjectivity score). For example—the use of the word “higher” instead of “better” in the exemplary sentence: “in over 10,000 simulations of Natural Language Processing of business communications, algorithm 1 achieved a better score than algorithm 2 when aiming for high objectivity,” improves the objectivity score of the overall sentence. In an embodiment, the system provides a warning that a subjective word or an inappropriate word is present in the business communication. Inappropriate textual connotation may be words that indicate racist, gender, national origin, or other prejudice.

Words do not occur independently of each other in the passage of any text. The conditional probability of any words that appear in a certain document is always zero in the presence of other words therein. In other words, the document does not comprise of an unstructured set of words. Many aspects of the English language come into play, such as complex grammar and a rich choice of vocabulary. The meaning of a particular word depends on the particular context in which they are used, the same word may have a specific meaning and tone in different contexts such as a business email, or a business report, or a business press release, or a personal email communication. Therefore, words in passage of the written communication are not independent of each other, but are rather mutually dependent.

Systems and methods for improving the tone of business communications is disclosed in this application.

In one embodiment, the system comprises of a search engine that is based on a keyword database, a processing algorithm that considers the relevance of the word in the business context by applying statistical analyses including proximity and logical operators whether the word in a business is relevant within the context of the communication.

In one embodiment, the system may further include an algorithm for information retrieval. Information retrieval refers to a process for discovering information relevant to the text being reviewed from an information repository or a database. The algorithm in the information retrieval system may further include identification of words that are associated with tone. The term retrieval as used here may be interchangeable with extraction.

In an embodiment, the system includes an algorithm for improving business communication, wherein, the algorithm determines word usage in a text by evaluating words in a business communication for objectivity according to one or more parameters that are defined for ensuring propriety of tone and content of the communication.

The system in a further embodiment identifies one or more words in the business communication that are associated with tone. The system may further evaluate the identified word in the business communication and compare the identified word with a database comprised of one or more synonymous words based on semantic properties of the flagged word, and assign it a score based on the objectivity.

In another embodiment, the system includes an algorithm for improving business communication, wherein, the algorithm determines word usage in a text by evaluating words in a business communication for objectivity according to one or more parameters that are defined for ensuring propriety of tone and content of the communication.

The system in a further embodiment identifies one or more words in the business communication that are associated with tone. The system may further evaluate the flagged word identified in the business communication and compare the flagged word with a database comprised of one or more synonymous words based on semantic properties of the flagged word, and assign it a score based on the objectivity. Further, the system may further perform a comparison of the flagged word with synonymous words in the database and further offer suggestions for replacing the flagged word with another word having a higher objectivity score than the flagged word to provide an improved tone in the business communication.

The system disclosed in the present application enables improved communications of the author with their audience and allows them to become proficient writers and communicators, leaving a smaller margin for misunderstanding. The system will inform the writer of the degree of subjectivity or objectivity of the text-based communication and provide a warning as to subjectivity or inappropriateness of the communication.

The system of the present disclosure may be developed as an internet browser plugin, an extension to a document creating/editing software product, or an email software. The system of the present application may be used as an overlay application for smartphones or offer similar functionality in a non-intrusive manner.

In an embodiment, the algorithm may use Natural Language Processing (NLP). The natural language processing algorithm may be an unsupervised algorithm, supervised algorithm, or a semi-supervised algorithm.

In an embodiment, the system comprises a flask web framework, a react library, a nitk, a gensim toolkits, or a numpy library. The system may also be remodeled to use other tools. In another embodiment, the system for improving business communication may comprise a user interface that identifies one or more words in the business communication associated with a tone and evaluates the objectivity of the identified or flagged word using a natural language processing algorithm; and further generates an objectivity score for the identified words. The user interface may be a JavaScript library which may comprise either annotated or un-annotated data.

In another embodiment, the system for improving business communication may comprise a user interface that uses a natural language processing algorithm to evaluate objectivity of the identified or flagged word for its tone and assign an objectivity score to the identified word.

In another embodiment, the system includes an interface, a memory, and a processor. The interface receives, from a first device associated with a requesting user, a request for evaluation of a written business communication. The requesting user may be associated with an enterprise group. The enterprise group comprises a plurality of users within an organization. The memory is operable to store information for each of the plurality of users in the enterprise group. A processor is communicatively coupled to the interface and the memory and is operable to determine, based on the request and the information related to the business communication, the objectivity of the business communication. The processor reads text in a business communication and identify words for evaluation of their objectivity.

In another embodiment, the system includes an interface, a memory, a processor, a library comprising text and words, and an algorithm for an objectivity rule. The interface receives, from a first device associated with a requesting user, a request for evaluation of a written business communication. The requesting user may be associated with an enterprise group. The enterprise group comprises a plurality of users within an organization. The memory is operable to store information for each of the plurality of users in the enterprise group. A processor is communicatively coupled to the interface and the memory and is operable to determine, based on the request and the information related to the business communication, the objectivity of the business communication. The processor reads text in a business communication and identify words for evaluation of their objectivity. The algorithm performs an objectivity determination using an objectivity rule and provides an objectivity score for the identified word.

In another embodiment, the system includes an interface, a memory, a processor, a library comprising text and words, and an algorithm for an objectivity rule. The interface receives, from a first device associated with a requesting user, a request for evaluation of a written business communication. The requesting user may be associated with an enterprise group. The enterprise group comprises a plurality of users within an organization. The memory is operable to store information for each of the plurality of users in the enterprise group. A processor is communicatively coupled to the interface and the memory and is operable to determine, based on the request and the information related to the business communication, the objectivity of the business communication. The processor reads text in a business communication and identify words for evaluation of their objectivity. The algorithm performs an objectivity determination using an objectivity rule and provides an objectivity score for the identified word. The system further comprises an objectivity score table that rates the objectivity score from low to high. The system further identifies one or more replacement words having a low objectivity score.

As used here, the terms “flagged word” and “identified word” are used interchangeably to mean the word that is identified for evaluation of its objectivity score.

### BRIEF DESCRIPTION OF THE DRAWINGS

For a more complete understanding of the present invention, the objects and advantages thereof, the present disclosure is further described in the detailed description which follows. In reference to the drawings, by way of non-limiting examples of preferred embodiments of the present disclosure, in which like characters represent like elements throughout the several views of the drawings.

FIG. 1 illustrates a system for generating an objectivity score for a word, according to one embodiment of the present disclosure;

FIG. 2 illustrates a method for improving objectivity of a written business communication, according to one embodiment of the present disclosure; and

FIG. 3 illustrates a method for improving objectivity of a written business communication, according to one embodiment of the present disclosure.

### DETAILED DESCRIPTION OF PREFERRED EMBODIMENTS

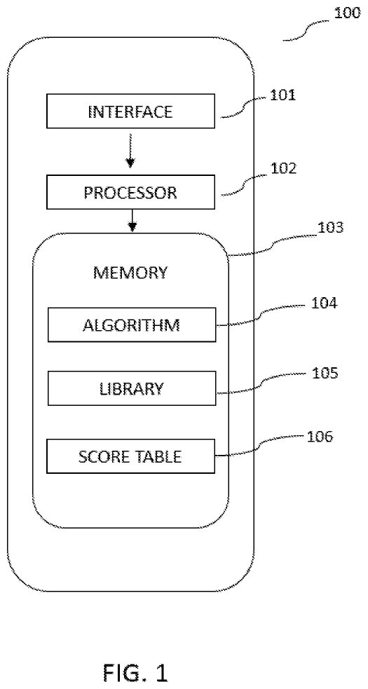

Embodiments of the present disclosure and its advantages are best understood by referring to FIGS. 1-3.

FIG. 1 depicts an exemplary system for improving written business communications using a system based on Natural Language Processing. The system (100) includes an interface (101), a processor (102), a memory (103), an algorithm (104), a library (105) comprising text and words, and a score table (106). The interface (101) receives, from a first device associated with a requesting user, a request for evaluation of a written business communication. The requesting user may be an individual or associated with an enterprise group. The enterprise group comprises a plurality of users within an organization. The memory (103) is operable to store information for each of the plurality of users in the enterprise group. The processor (102) is communicatively coupled to the interface (101) and the memory (103) and is operable to determine, based on the request and the information related to the business communication, the objectivity of the business communication. The processor (102) reads text in a business communication and identifies words for evaluation of their objectivity. The algorithm (104) performs an objectivity determination and provides an objectivity score for the identified word.

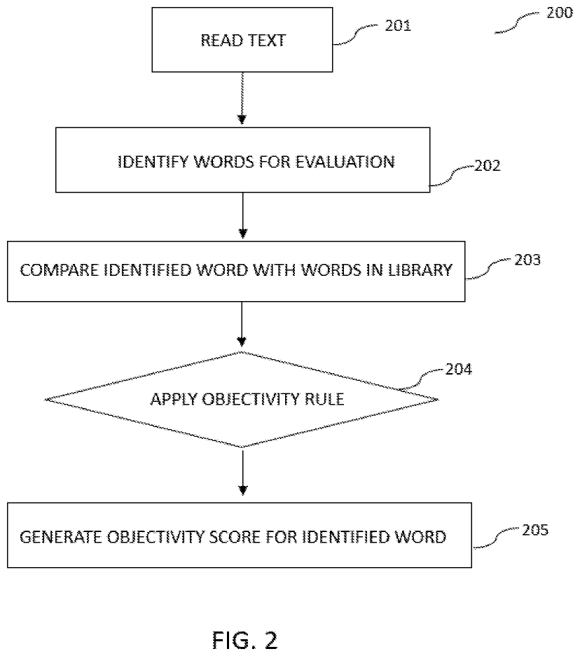

FIG. 2 depicts a method (200) for improving objectivity of business communications using natural language processing, wherein, the first step of the method is reading of the text (201) of business communication. In step 202, the system identifies words for evaluation of objectivity, and compares the identified word with words in the library (203). The next step involves the application of an objectivity rule (204) for evaluating the objectivity of identified words in the business communication. In step 205, the system generates an objectivity score for the identified word.

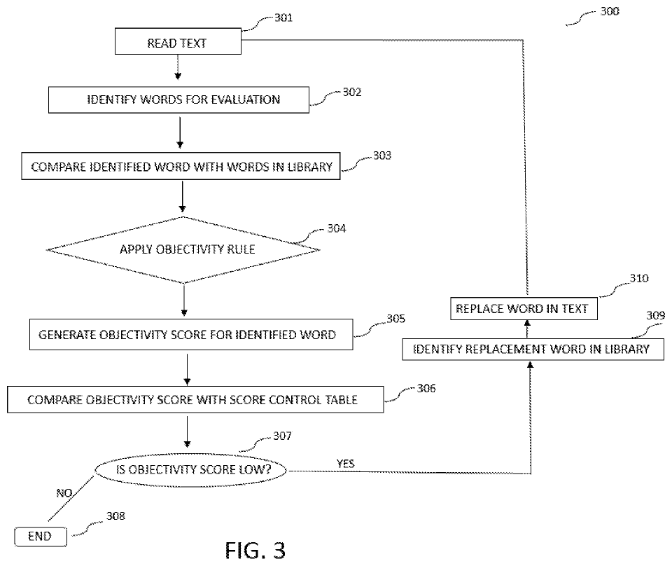

FIG. 3 illustrates an embodiment of the present disclosure for evaluation of a business communication for its objectivity and improvement of its objectivity. In step 301 of the method (300), the system reads the text in the business communication. In step 302 of the method, words for evaluation of objectivity are identified. The identified word is then compared with words in the library in step 303, following which an objectivity rule is applied in step 304. The application of the objectivity rule generates an objectivity score in step 305. This objectivity score is compared with a score control table in step 306. In the next step (307), the method determines whether the objectivity score is low. If the score is low, the method identifies a replacement word (step 309), and the word with the low objectivity score is replaced in the text in step 310. The text is re-evaluated for its objectivity using steps 301 through 307. The method ends when the objectivity score is not low (step 308).

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language. Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example. In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention. Accordingly, while the present disclosure has been described here in detail in relation to its exemplary embodiments, it is to be understood that this disclosure is only illustrative and exemplary of the present disclosure and is made to provide an enabling disclosure of the invention. Accordingly, the foregoing disclosure is not intended to be construed or to limit the present disclosure or otherwise to exclude any other such embodiments, adaptations, variations, modifications or equivalent arrangements.

What is claimed is:

1. A system for improving business communication, the system comprising:
a processor;
a memory;
and
a user interface coupled to each of the processor, and the memory, wherein the processor is configured to:
receive, from a client device, a text of a business communication;
read the text of a business communication;
identify one or more words in the text of the business communication for evaluation of objectivity;
apply an objectivity rule; and
generate an objectivity score for the one or more identified words.

2. The system of claim 1, wherein the one or more words identified in the business communication is assigned an objectivity score.

3. The system of claim 1, wherein the one or more words identified in the business communication is compared with a library comprised of one or more replacement words based on semantic properties of the word, and assigned a score based on the objectivity.

4. The system of claim 1, wherein the algorithm is a natural language processing algorithm.

5. The system of claim 4, wherein the natural language processing algorithm is an unsupervised algorithm.

6. The system of claim 4, wherein the natural language processing algorithm is a supervised algorithm.

7. The system of claim 4, wherein the natural language processing algorithm is a semi-supervised algorithm.

8. A method for improving business communication, the method comprising the steps of:
reading a text of a business communication;
identifying one or more words in the text of the business communication for evaluation of objectivity;
applying an objectivity rule;
generating an objectivity score for the one or more identified words;
comparing the objectivity score with a score control table; and
identifying a replacement word for an identified word with a low objectivity score.

9. The method of claim 8, wherein, the business communication comprises of an email, a report, a news article, a press release, a newsletter, or a letter.

10. A system for improving business communication, the system comprising:
a processor;
a memory;
and
a user interface coupled to each of the processor, and the memory,
wherein the processor is configured to:
receive, from a client device, a text of a business communication;
read the text of a business communication;
identify one or more words in the text of the business communication for evaluation of objectivity;
apply an objectivity rule;
generate an objectivity score for the one or more identified words;
compare the objectivity score with a control table;
determine whether the objectivity score is low; and
identify a replacement word in a library for a word with a low objectivity score.

11. The system of claim 10, wherein the one or more words identified in the business communication is assigned an objectivity score.

12. The system of claim 10, wherein the one or more words identified in the business communication is compared with a library comprised of one or more replacement words based on semantic properties of the word, and assigned a score based on the objectivity.

13. The system of claim 10, wherein the algorithm is a natural language processing algorithm.

14. The system of claim 13, wherein the natural language processing algorithm is an unsupervised algorithm.

15. The system of claim 13, wherein the natural language processing algorithm is a supervised algorithm.

16. The system of claim 13, wherein the natural language processing algorithm is a semi-supervised algorithm.
